(19) United States
(12) Patent Application Publication
(10) Pub. No.: US 2010/0186727 A1
(43) Pub. Date: Jul. 29, 2010

(54) CONTROL DEVICE FOR INTERNAL COMBUSTION ENGINE, AND CONTROL METHOD THEREOF

(76) Inventor: Tomohiro Kaneko, Shizuoka-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/663,863

(22) PCT Filed: Jun. 13, 2008
(86) PCT No.: PCT/IB08/01513

§ 371 Date: Dec. 10, 2009

(30) Foreign Application Priority Data
Jun. 14, 2007 (JP) 2007-157070

(51) Int. Cl. F02B 47/08

(52) U.S. Cl. 123/568.21

(57) ABSTRACT

A control device for an internal combustion engine (100) controls the internal combustion engine (100) that includes a first EGR device (51) that recirculates exhaust gas from a downstream side of a turbine (23b) to an upstream side of a compressor (23a), and a second EGR device (50) that recirculates exhaust gas from the upstream side of the turbine (23b) to the downstream side of the compressor (23a). EGR control device (7) performs such a control as to change the recirculation of exhaust gas from the recirculation of exhaust gas using the second EGR device (50) to the recirculation of exhaust gas using the first EGR device (51) when the idling-stop is to be executed.

### BACKGROUND OF THE INVENTION

1. Field of the Invention

The invention relates to a control device for an internal combustion engine in which a portion of exhaust gas is recirculated to an intake system, and a control method of the control device.

2. Description of the Related Art

In conjunction with internal combustion engines, such as diesel engines and the like, EGR devices (Exhaust Gas Recirculation devices) have been known which return a portion of the exhaust gas from an exhaust passage to an intake passage and therefore reduce the combustion temperature in the engine so as to restrain the production of NOx and the like. For example, technologies using an EGR device that recirculates exhaust gas from a location in an exhaust passage on an upstream side of a catalyst to an intake side (hereinafter, referred to as “high-pressure EGR device”) have been proposed. For example, Japanese Patent Application Publication No. 2003-262138 (JP-A-2003-262138) describes a technology employed in an internal combustion engine equipped with a high-pressure EGR device as described above which restrains the occurrence of a change in combustion noise and a change in combustion by causing a state in which gas that flows into a cylinder remains even at the time of the final fuel injection when the engine is automatically stopped.

However, in the foregoing technology described in Japanese Patent Application Publication No. 2003-262138 (JP-A-2003-262138), the path length of the high-pressure EGR device is relatively short, and restriction of the amount of fresh air results in the replacement by the EGR gas. Because of these causes and the like, it sometimes becomes difficult to control the high-pressure EGR device, so that during stop of the engine (during a fall of the engine rotation speed), the EGR rate cannot be appropriately maintained. Hence, in some cases, during stop of the engine, EGR gas moves into the cylinders, so that vibration occurs in the cylinders, or the EGR gas decreases, so that the change in combustion noise becomes large.

### SUMMARY OF THE INVENTION

The invention provides a control device for an internal combustion engine that is capable of effectively restraining the occurrence of a change in combustion noise and a change in combustion or the like during execution of an idling-stop control.

In a first aspect of the invention, there is provided a control device for an internal combustion engine including: a first EGR device that recirculates exhaust gas from a location in an exhaust passage at a downstream side of a turbine of a turbocharger to a location in an intake passage at an upstream side of a compressor of the turbocharger; and a second EGR device that recirculates exhaust gas from a location in the exhaust passage at an upstream side of the turbine to a location in the intake passage at a downstream side of the compressor. The control device includes EGR control means for performing a control such that recirculation of exhaust gas is changed from the recirculation of exhaust gas using the second EGR device to the recirculation of exhaust gas using the first EGR device when idling-stop is to be performed on the internal combustion engine.

The foregoing control device for the internal combustion engine is suitably used to perform a control on an internal combustion engine that is equipped with a first EGR device and a second EGR device. In this case, the first EGR device (hereinafter, referred to also as “the low-pressure EGR device”) recirculates exhaust gas from the location in the exhaust passage at the downstream side of the turbine of the turbocharger to the location in the intake passage at the upstream side of the compressor. Besides, the second EGR device (hereinafter, referred to as “the high-pressure EGR device”) recirculates exhaust gas from the location in the exhaust passage at the upstream side of the turbine to the location in the intake passage at the downstream side of the compressor. Then, when the idling-stop is to be executed on the internal combustion engine, the EGR control means performs a control such that the recirculation of exhaust gas is changed from the recirculation of exhaust gas using the high-pressure EGR device to the recirculation of exhaust gas using the low-pressure EGR device. That is, when the idling-stop is to be executed, exhaust gas is recirculated by the low-pressure EGR device. Therefore, when intake is throttled by the throttle valve, EGR gas can be introduced at a stable EGR rate. That is, since exhaust gas is recirculated by the low-pressure EGR device during the transition to a stop of the internal combustion engine, it is possible to stop the internal combustion engine while keeping substantially constant the oxygen concentration of a gas supplied to the internal combustion engine, merely by the control of throttling intake gas via the throttle valve. Thus, according to the control device for the internal combustion engine, the occurrence of vibrations when the idling-stop is being executed can be effectively restrained. Concretely, it becomes possible to effectively restrain the occurrence of a change in combustion noise, a change in combustion, etc.

In the first aspect, if a warm-up condition for the internal combustion engine is not satisfied when the idling-stop is to be executed, the EGR control means may perform a control such that the exhaust gas is recirculated the second EGR device.

In this aspect, in the case where the warm-up condition is not satisfied, the change from the recirculation of exhaust gas using the high-pressure EGR device to the recirculation of exhaust gas using the low-pressure EGR device is prohibited to recirculate exhaust gas by the high-pressure EGR device. Therefore, it becomes possible to restrain the occurrence of a change in combustion noise, a change in combustion, etc. while restraining the occurrence of misfire.

In the first aspect, if the exhaust gas is already being recirculated by the first EGR device when the idling-stop is to be executed, the EGR control means may perform such a control as to increase proportion of the exhaust gas recirculated by the first EGR device to a total amount of exhaust gas recirculated by the first EGR device and the second EGR device.

A second aspect of the invention, there is provided a control method for an internal combustion engine including: a first EGR device that recirculates exhaust gas from a location in an exhaust passage at a downstream side of a turbine of a turbocharger to a location in an intake passage at an upstream side of a compressor of the turbocharger; and a second EGR device that recirculates exhaust gas from a location in the exhaust passage at an upstream side of the turbine to a location in the intake passage at a downstream side of the compressor. The control method includes performing a control of changing recirculation of exhaust gas from the recirculation of exhaust gas using the second EGR device to the recirculation of exhaust gas using the first EGR device when idling-stop is to be performed on the internal combustion engine.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a block diagram showing a general construction of an internal combustion engine in accordance with an embodiment of the invention;

FIG. 2 is a diagram showing an example of operation regions of a high-pressure EGR device and a low-pressure EGR device;

FIG. 3 is a diagram for describing an EGR control in accordance with a first embodiment of the invention;

FIG. 4 is a flowchart showing an EGR control process in accordance with the first embodiment;

FIG. 5 is a diagram for describing a control in accordance with a comparative example;

FIG. 6 is a diagram showing an example of results of execution of a control in accordance with the first embodiment and a control of the comparative example;

FIG. 7 is a diagram for describing a EGR control in accordance with a second embodiment of the invention; and

FIG. 8 is a flowchart showing an EGR control process in accordance with the second embodiment.

### DETAILED DESCRIPTION OF EMBODIMENTS

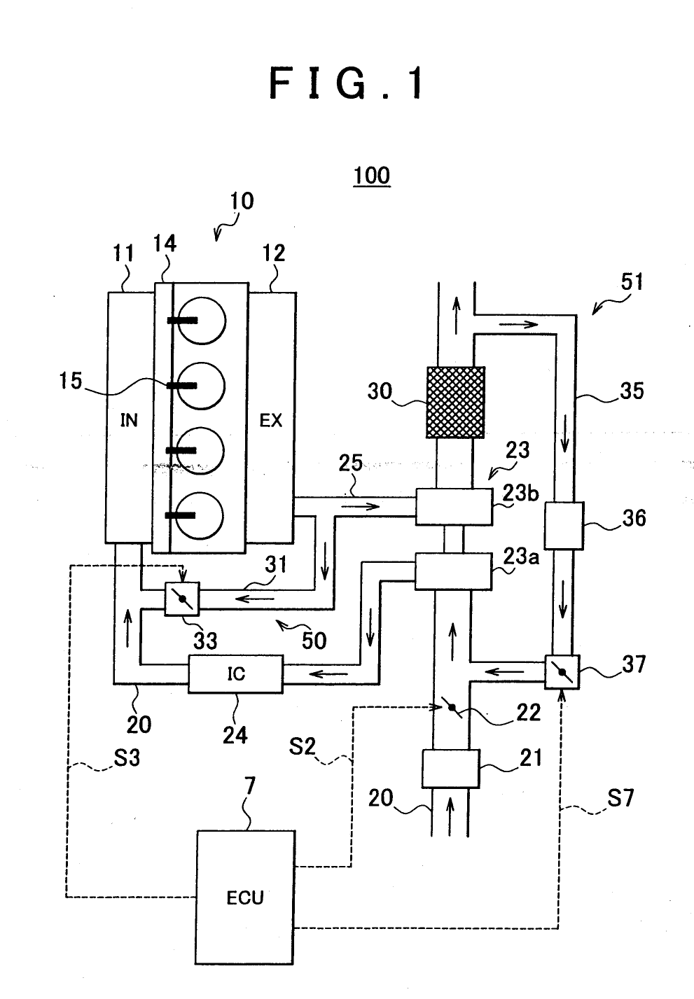

Hereinafter, embodiments of the invention will be described with reference to the drawings.

[DEVICE CONSTRUCTION] FIG. 1 is a block diagram showing a general construction of an internal combustion engine 100 to which a control device for an internal combustion engine in accordance with an embodiment is applied. In FIG. 1, solid-line arrows show flows of intake gas and exhaust gas, and dashed-line arrows show the input/output of signals.

An internal combustion engine 100 shown in FIG. 1 is mounted in a vehicle, so that the output of an engine body 10 constructed as an in-line four-cylinder diesel engine is used as a traveling motive power source. The cylinders of the engine body 10 are connected to an intake manifold 11 and an exhaust manifold 12. The engine body 10 includes fuel injection valves 15 provided for the individual cylinders, and a common rail 14 that supplies high-pressure fuel to each fuel injection valve 15. The common rail 14 is supplied with fuel in a high-pressure state by a fuel pump (not shown).

An intake passage 20 connected to the intake manifold 11 is provided with an air flow meter 21 that detects the amount of air taken into the engine body 10, a throttle valve 22 that adjusts the amount of intake air, a compressor 23a of a turbocharger 23 that supercharges intake gas, and an intercooler (IC) 24 that cools intake gas. In this case, the throttle valve 22 is controlled in its degree of opening (hereinafter, referred to as “the throttle opening degree”) and the like by a control signal S2 that is supplied from an ECU 7 described below.

On the other hand, an exhaust passage 25 connected to the exhaust manifold 12 is provided with a turbine 23b of the turbocharger 23 that is rotated by energy of exhaust gas, and a catalyst 30 capable of purifying exhaust gas. As the catalyst 30 herein, for example, an oxidation catalyst, a DPF (Diesel Particulate Filter), etc. may be used.

The internal combustion engine 100 further includes a high-pressure EGR device 50 that recirculates exhaust gas from an upstream side of the turbine 23b to a downstream side of the compressor 23a, and a low-pressure EGR device 51 that recirculates exhaust gas from a downstream side of the turbine 23b and the catalyst 30 to an upstream side of the compressor 23a. The high-pressure EGR device 50 has a high-pressure EGR passage 31 and a high-pressure EGR valve 33. The high-pressure EGR passage 31 is a passage that connects a location in the exhaust passage 25 upstream of the turbine 23b and a location in the intake passage 20 downstream of the intercooler 24. The high-pressure EGR passage 31 is provided with the high-pressure EGR valve 33 for controlling the amount of exhaust gas recirculated. The high-pressure EGR valve 33 is controlled in its degree of opening (hereinafter, referred to as “the high-pressure EGR valve opening degree”) and the like by a control signal S3 that is supplied from the ECU 7.

On the other hand, the low-pressure EGR device 51 has a low-pressure EGR passage 35, an EGR cooler 36, and a low-pressure EGR valve 37. The low-pressure EGR passage 35 is a passage that connects a location in the exhaust passage 25 downstream of the catalyst 30 and a location in the intake passage 20 upstream of the compressor 23a. The low-pressure EGR passage 35 is provided with the EGR cooler 36 that cools the exhaust gas recirculated, and the low-pressure EGR valve 37 for controlling the amount of exhaust gas recirculated. The low-pressure EGR valve 37 is controlled in its degree of opening (hereinafter, referred to as “the low-pressure EGR valve opening degree”) and the like by a control signal S7 that is supplied from the ECU 7. Incidentally, the low-pressure EGR device 51 corresponds to a first EGR device, and the high-pressure EGR device 50 corresponds to a second EGR device in the invention.

Various elements of the internal combustion engine 100 are controlled by the ECU (Electronic Control Unit) 7. The ECU 7 is constructed having a CPU (Central Processing Unit), a ROM (Read-Only Memory), a RAM (Random Access Memory), etc. although not shown in the drawings. The ECU 7 acquires outputs of various sensors (not shown) provided in the internal combustion engine 100, and performs control of various component elements of the internal combustion engine 100 on the basis of the acquired sensor outputs. In this embodiment, the ECU 7 performs control of the recirculation of exhaust gas performed by the high-pressure EGR device 50 and the low-pressure EGR device 51 described above (hereinafter, referred to also as “the EGR control”) on the basis of the operation state of the internal combustion engine 100, and the like. Concretely, the ECU 7 performs the switching among a mode of recirculating exhaust gas by using only the high-pressure EGR device 50 (hereinafter, referred to as “the HPL mode”), a mode of recirculating exhaust gas by using only the low-pressure EGR device 51 (hereinafter, referred to as “the LPL mode”), a mode of recirculating exhaust gas by using both the high-pressure EGR device 50 and the low-pressure EGR device 51 (hereinafter, referred to as “the MPL mode”), etc. Specifically, the ECU 7 executes the switching among the modes as described above, by performing control of the high-pressure EGR valve 33, the low-pressure EGR valve 37, etc. In this case, the ECU 7 executes the control by supplying the control signals S3, S7 to the high-pressure EGR valve 33 and the low-pressure EGR valve 37.

Thus, the ECU 7 corresponds to a control device for an internal combustion engine in the invention. Concretely, the ECU 7 operates as EGR control means. In addition, although the ECU 7 performs controls of other component elements of the internal combustion engine 100, descriptions of portions or contents that are not particularly relevant to the embodiment are omitted.

In addition, the invention is not limited to the application to the in-line four-cylinder internal combustion engines, but is also applicable to internal combustion engines whose number of cylinders is other than four, and internal combustion engines in which the cylinders are laid out in a V-arrangement. Furthermore, the invention is not limited to the application to the internal combustion engine 100 that includes direct-injection type fuel injection valves 15, but is also applicable to internal combustion engines that include port injection-type fuel injection valves.

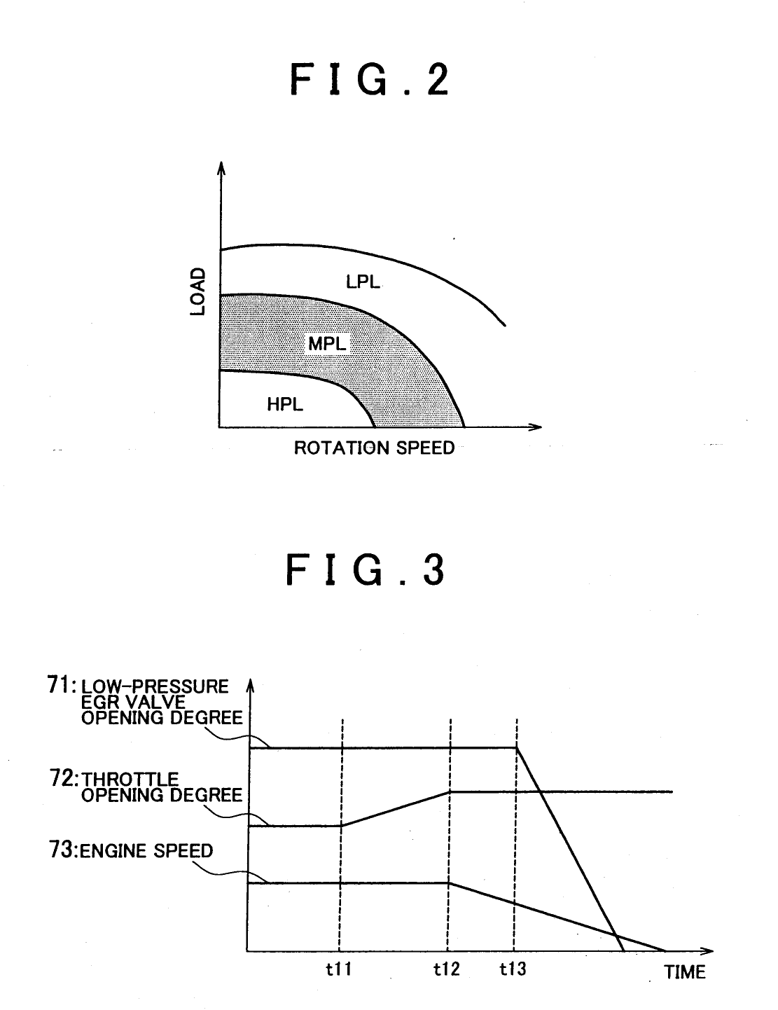

An example of operation regions of the high-pressure EGR device 50 and the low-pressure EGR device 51 will be described with reference to FIG. 2. In FIG. 2, the horizontal axis shows the rotation speed of the internal combustion engine 100, and the vertical axis shows the load of the internal combustion engine 100. Concretely, a region marked with “HPL” shows a region in which only the high-pressure EGR device 50 is used (hereinafter, referred to as “the HPL region”). A region marked with “MPL” (region indicated by shading) shows a region in which both the high-pressure EGR device 50 and the low-pressure EGR device 51 are used (hereinafter, referred to as “the MPL region”). Furthermore, a region marked with “LPL” shows a region in which only the low-pressure EGR device 51 is used (hereinafter, referred to as “the LPL region”).

Basically, the ECU 7 controls the switching among the modes as described above, in accordance with relations among the regions as shown in FIG. 2. In addition, in the case where an idling-stop condition is satisfied, ECU 7 controls the switching of the modes, not by following the relations among the regions as shown in FIG. 2, but by following a method as described below.

### First Embodiment

Next, the EGR control that the ECU 7 performs in a first embodiment will be described.

In the first embodiment, the ECU 7 performs the EGR control so that exhaust gas is recirculated by the low-pressure EGR device 51 in the case where the idling-stop condition is satisfied in the internal combustion engine 100. That is, the ECU 7 performs the control so that the mode is changed from the HPL mode to the LPL mode at the time of execution of the idling-stop. Concretely, the ECU 7 performs the change from the LPL mode to the HPL mode by performing a control of closing the high-pressure EGR valve 33 and opening the low-pressure EGR valve 37. Furthermore, when executing the idling-stop, the ECU 7 throttles the intake air amount by performing a control of gradually closing the throttle valve 22. In addition, the ECU 7 determines that the idling-stop condition is satisfied, when a condition that the internal combustion engine 100 be in a state in which the internal combustion engine 100 can be stopped (e.g., a state in which the internal combustion engine 100 is being warmed up) is satisfied in a situation in which the idling-stop needs to be performed, such as a situation in which the vehicle is in a stopped state, a situation in which the accelerator pedal is not depressed, a situation in which the transmission gear is in a neutral position, etc.

The above-described EGR control is performed because, by recirculating exhaust gas via the low-pressure EGR device 51 at the time of execution of the idling-stop, EGR gas can be introduced at a stable EGR rate (a proportion between the EGR gas and fresh air supplied to the internal combustion engine) when the intake gas is throttled by the throttle valve 22. In other words, if exhaust gas is recirculated from the low-pressure EGR device 51 during transition to a stop of the internal combustion engine 100, the mere performance of the control of throttling the intake air via the throttle valve 22 makes it possible to stop the internal combustion engine 100 while keeping substantially constant the oxygen concentration of the gas supplied to the internal combustion engine 100. Thus, according to the EGR control in accordance with the first embodiment, it becomes possible to effectively restrain the occurrence of a change in combustion noise, a change in combustion, and the like at the time of execution of the idling-stop. That is, it becomes possible to restrain vibration that can occur at the time of execution of idling-stop.

Next, with reference to FIG. 3, an example of the EGR control in accordance with the first embodiment will be described. In FIG. 3, the horizontal axis shows time, and graph curves 71 to 73 are shown in an overlapped fashion. Concretely, the graph curve 71 shows the low-pressure EGR valve opening degree, the graph curve 72 shows the throttle opening degree, and the graph curve 73 shows the rotation speed of the internal combustion engine 100.

In this case, at a time t11, the idling-stop condition is satisfied. For example, a request for an economy run is output. At this time, the ECU 7 starts the control of reducing the opening degree of the throttle valve 22. Then, when the throttle valve 22 has a predetermined opening degree (that is an opening degree that allows combustion, for example, an opening degree of 10%), the ECU 7 executes a final injection (time t12). Therefore, substantially from the time t12 on, the rotation speed of the internal combustion engine 100 decreases. Besides, at least during the period from the time t11 to the time t12 (while the opening degree of the throttle valve 22 is being reduced), the ECU 7 keeps the low-pressure EGR valve 37 open, that is, keeps the low-pressure EGR valve opening degree substantially constant.

As described above, in the case where the low-pressure EGR device 51 is being used, the mere performance of the control of throttling the intake air via the throttle valve 22, without the performance of the control of the low-pressure EGR valve 37, will stop the internal combustion engine 100 while maintaining the oxygen concentration supplied to the internal combustion engine 100. Therefore, the control of the low-pressure EGR valve 37 and the like at the final injection position becomes unnecessary, and it suffices to control only the throttle valve 22; thus, the controllability can be said to be good. In addition, in a situation in which the idling-stop condition is satisfied, the idling-stop time (substantially the duration from the time t11 to the time t12) is relatively short, it can be considered that the influence of the decrease in the intake gas temperature caused by the recirculation of exhaust gas performed by the low-pressure EGR device 51 is small.

After that, the ECU 7 starts a control of closing the low-pressure EGR valve 37 at the time t13 at which a certain amount of time has passed following the time t12. That is, the ECU 7 closes the low-pressure EGR valve 37 after the internal combustion engine 100 has stopped. In addition, the closing of the low-pressure EGR valve 37 after the internal combustion engine 100 stops is not restrictive. For example, the low-pressure EGR valve 37 may be kept open, and the low-pressure EGR valve opening degree may be maintained as it is.

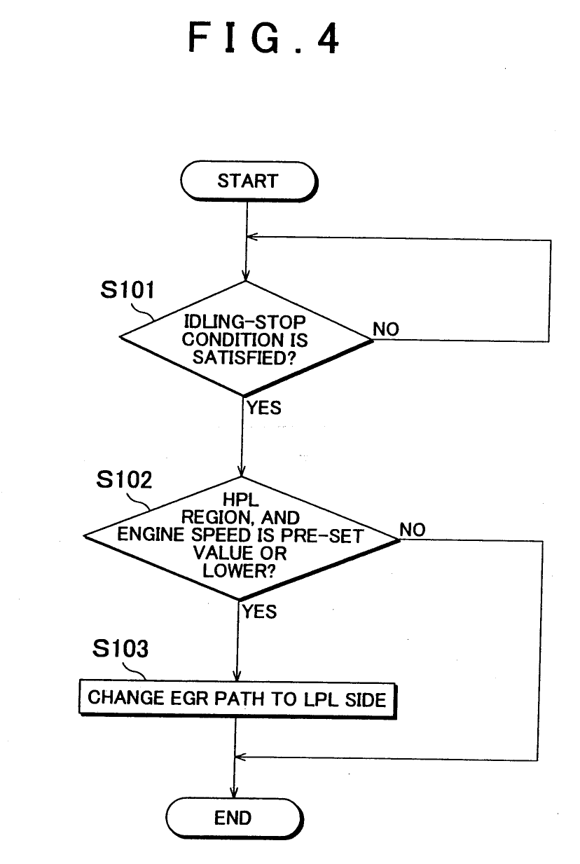

Next, an EGR control process in accordance with the first embodiment will be described with reference to FIG. 4. FIG. 4 is a flowchart showing the EGR control process in accordance with the first embodiment. This process is executed by the ECU 7.

Firstly in step S101, the ECU 7 determines whether or not the idling-stop condition is satisfied. In other words, the ECU 7 determines whether or not the economy-run condition is satisfied. Concretely, the ECU 7 firstly determines whether or not to perform the idling-stop, on the basis of whether the vehicle is in a stopped state, whether the accelerator is in an undepressed state, whether the transmission gear is in the neutral state, etc. Then, the ECU 7 determines whether or not the internal combustion engine 100 is in a state in which the engine 100 can be stopped in the case where a request regarding the vehicle or the like (the economy-run request) has been output in the present situation, on the basis of the warmup state of the internal combustion engine 100 or the like (concretely, on the basis of the water temperature or the like). If the idling-stop condition is satisfied (YES at step S101), the process proceeds to step S102. On the other hand, if the idling-stop condition is not satisfied (NO at step S101), the process proceeds to step S101.

In step S102, the ECU 7 determines whether or not the present EGR operation region is the HPL region and the rotation speed of the internal combustion engine 100 is less than or equal to a predetermined value. That is, the ECU 7 determines whether or not exhaust gas is being recirculated only by the high-pressure EGR device 50 and the engine rotation speed is less than or equal to the predetermined value. In the determination process in step S102, the ECU 7 basically determines whether or not the present situation allows the change from the HPL mode to the LPL mode. Incidentally, the predetermined value used for the determination regarding the engine rotation speed is a rotation speed of the engine that is close to an idling rotation speed. Besides, the ECU 7 determines whether or not the present operation region is the HPL region on the basis of the operation state of the internal combustion engine 100 (rotation speed, load, etc.). For example, the ECU 7 performs the aforementioned determination on the basis of the relation among the regions as show in FIG. 2.

If the present operation region is the HPL region and the engine rotation speed is less than or equal to the predetermined (YES at step S102), the process proceeds to step S103. On the other hand, if the present operation region is not the HPL region or if the engine rotation speed is higher than the predetermined value (NO at step S102), the process exits this flow.

In step S103, the ECU 7 performs the change from the HPL mode to the LPL mode. That is, the ECU 7 performs a control such that the EGR gas flows in a path on the low-pressure EGR device side (the low-pressure EGR passage 35). Concretely, the ECU 7 changes the recirculation mode from the HPL mode to the LPL mode by performing the control of closing the high-pressure EGR valve 33 and also opening the low-pressure EGR valve 37. In a situation in which the process of step S103 has been reached, it can be considered that when the idling-stop condition is satisfied, the request for the idling-stop (in other words, the economy-run request) is immediately output, and therefore the internal combustion engine 100 will come to stop. Due to the above-described utilization of the low-pressure EGR device 51 during the transition of the internal combustion engine 100 to a stop, the mere performance of the control of throttling the intake air via the throttle valve 22 will stop the internal combustion engine 100 while keeping substantially constant the oxygen concentration of the gas supplied to the internal combustion engine 100. This makes it possible to effectively restrain vibration at the time of execution of the idling-stop. Concretely, it becomes possible to effectively restrain the occurrence of a change in combustion noise, and a change in combustion, etc. After the foregoing process ends, the process exits this flow.

For comparison with the foregoing control in accordance with the first embodiment, a control in accordance with a comparative example will be described. In the comparative example, in the case where the idling-stop condition is satisfied, the foregoing control of changing the recirculation mode from the HPL mode to the LPL mode is not executed. Specifically, in the comparative example, a control of recirculating exhaust gas only via the high-pressure EGR device 50 is performed at the time of execution of the idling-stop.

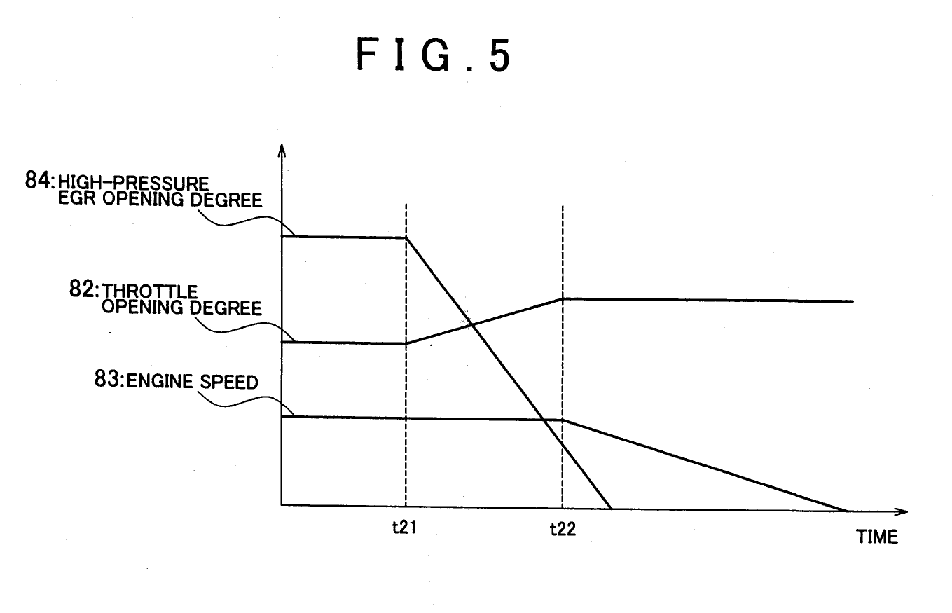

FIG. 5 is a diagram for describing the control in accordance with the comparative example. In FIG. 5, the horizontal axis shows time, and graph curves 82 to 84 are shown in an overlapped fashion. Concretely, the graph curve 82 shows the throttle opening degree, and the graph curve 83 shows the engine rotation speed, and the graph curve 84 shows the high-pressure EGR valve opening degree. In this case, the idling-stop condition is satisfied at a time t21. In the comparative example, when the idling-stop condition is satisfied, the control of reducing the opening of the throttle valve 22 is started, and the control of closing the high-pressure EGR valve 33 of the high-pressure EGR device 50 is performed. Then, with the throttle valve 22 being at a predetermined opening degree (an opening degree that allows combustion), the final injection is executed (time t22). This results in decrease in the engine rotation speed following the time t22.

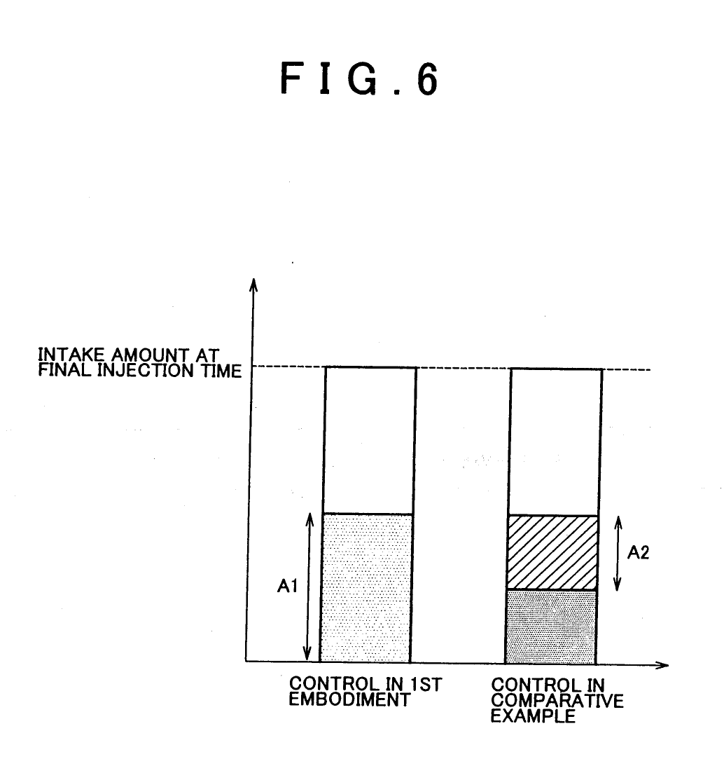

Next, with reference to FIG. 6, results of the execution of the control in accordance with the first embodiment and results of the execution of the control in accordance with the comparative example will be compared. Concretely, in FIG. 6, the amount of intake gas is shown in the vertical direction, and an example of results obtained from the control in accordance with the first embodiment is shown by the left-side bar, and an example of results obtained from the control in accordance with the comparative example is shown by right-side bar. Besides, in FIG. 6, shaded portions of the bars correspond to the amounts of EGR contained in the gas supplied to the internal combustion engine 100. In addition, the height of the bars shown in FIG. 6 corresponds to the in-cylinder intake gas amount in the engine body 10 at the time of the final injection.

In the case where the control in accordance with the first embodiment is executed, the EGR gas amount becomes substantially constant as shown by an arrowed line A1 in FIG. 6. That is, the EGR gas rate becomes substantially constant. This is because in the case where the control in accordance with the first embodiment is executed, the EGR rate is substantially determined at a stage before the throttle valve 22. Thus, according to the first embodiment, since the EGR gas rate can be made substantially constant when the idling-stop is executed, the occurrence of a change in combustion noise, a change in combustion, etc. can be said to be effectively restrained.

On the other hand, in the case where the control in accordance with the comparative example is executed, the EGR rate fluctuates as shown by an arrowed line A2 in FIG. 6. Such fluctuations in the EGR rate are considered to be attributed to the opening degree of the high-pressure EGR valve 33 of the high-pressure EGR device 50. In the case where the EGR rate fluctuates in this manner at the time of execution of the idling-stop, there can occur changes in combustion noise, changes in combustion, etc.

### Second Embodiment

Next, the EGR control that the ECU 7 performs in the second embodiment will be described.

In the second embodiment, too, the ECU 7 performs such a control as to change the recirculation mode from the HPL mode to the LPL mode in the case where the idling-stop condition is satisfied in the internal combustion engine 100. However, in the second embodiment, in the case where a warm-up condition for the internal combustion engine 100 is not satisfied even though the idling-stop condition is satisfied, the ECU 7 performs such a control that exhaust gas is recirculated only by the high-pressure EGR device 50. That is, in that case, the change from the HPL mode to the LPL mode is not performed. This is because in the case where the warm-up condition is not satisfied, there is a possibility of the change from the HPL mode to the LPL mode causing misfire. That is, in the second embodiment, in the case where the warm-up condition is not satisfied, the change from the HPL mode to the LPL mode is prohibited in order to give priority to restraining misfire.

Furthermore, in the second embodiment, in the case where exhaust gas has already been being recirculated by the low-pressure EGR device 51 when the idling-stop condition is satisfied, the ECU 7 performs such a control as to increase the proportion of the EGR gas recirculated by the low-pressure EGR device 51 to the total EGR gas recirculated by the high-pressure EGR device 50 and the low-pressure EGR device 51 (hereinafter, referred to as “the low-pressure EGR proportion”). That is, in the case where the low-pressure EGR device 51 has already been being used, the ECU 7 performs such a control as to increase the dependency on the low-pressure EGR device side in order to lessen the dependency on the high-pressure EGR device side. In this case, the ECU 7 performs such a control that the low-pressure EGR proportion increases while the EGR rate is kept constant.

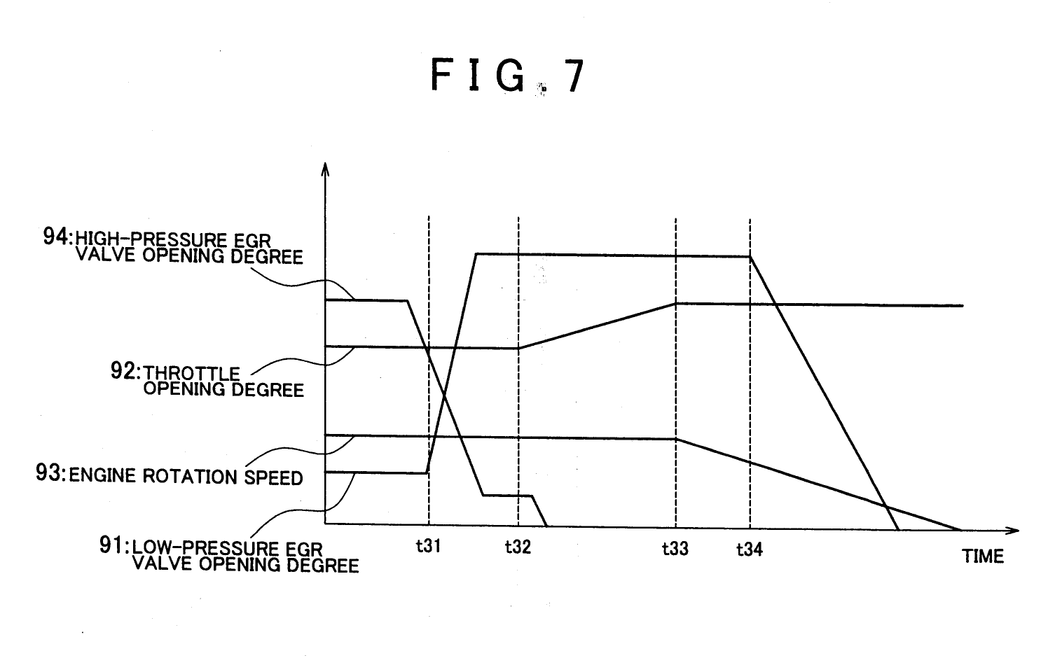

Next, with reference to FIG. 7, an example of the EGR control in accordance with the second embodiment will be concretely described. Here, an example of a control of increasing the low-pressure EGR proportion will be described.

In FIG. 7, the horizontal axis shows time, and graph curves 91 to 94 are shown in an overlapped fashion. Concretely, the graph curve 91 shows the low-pressure EGR valve opening degree, and the graph curve 92 shows the throttle opening degree, and the graph curve 93 shows the engine rotation speed, and the graph curve 94 shows the high-pressure EGR valve opening degree. In this case, at a time t31, the ECU 7 performs a control of gradually closing the high-pressure EGR valve 33, and a control of gradually opening the low-pressure EGR valve 37. That is, at the time t31, the ECU 7 executes the foregoing controls because at the time t31 the low-pressure EGR device 51 is already being used (i.e., because the low-pressure EGR valve 37 is in a slightly open state). This will increase the low-pressure EGR proportion. In other words, this will lessen the dependency on the high-pressure EGR device side, and will increase the dependency on the low-pressure EGR device side.

After that, at a time t32, the ECU 7 starts a control of reducing the opening of the throttle valve 22. Then, when the throttle valve 22 is at a predetermined opening degree (an opening degree that allows combustion), the ECU 7 executes a final injection (time t33). Thus, from the time t33 on, the rotation speed of the internal combustion engine 100 decreases. After that, at a time t34 at which a certain amount time elapses from the time t33, the ECU 7 starts a control of closing the low-pressure EGR valve 37. Incidentally, the closing of the low-pressure EGR valve 37 after the internal combustion engine 100 stops is not restrictive; for example, instead of closing the low-pressure EGR valve 37, the low-pressure EGR valve opening degree may be maintained as it is.

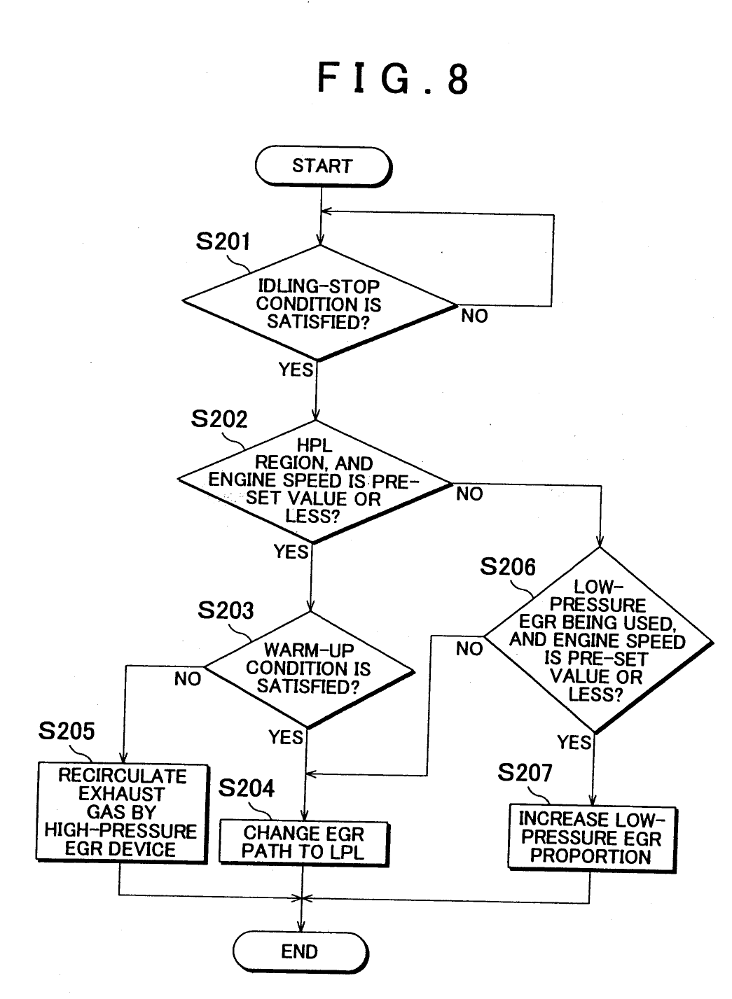

Next, with reference to FIG. 8, an EGR control process in accordance with the second embodiment will be described. FIG. 8 is a flowchart showing the EGR control process in accordance with the second embodiment. This process is executed by the ECU 7.

Firstly in step S201, similar to step S101 described above, the ECU 7 determines whether or not the idling-stop condition is satisfied. In the case where the idling-stop condition is satisfied (YES at step S201), the process proceeds to step S202. On the other hand, in the case where the idling-stop condition is not satisfied (NO at step S201), the process returns to step S201.

In step S202, similar to step S102 described above, the ECU 7 determines whether or not the present operation region is the HPL region and the rotation speed of the internal combustion engine 100 is less than or equal to a predetermined value. In the case where the present operation region is the HPL region and the engine rotation speed is less than or equal to the predetermined value (YES at step S202), the process proceeds to step S203. On the other hand, in the case where the present operation region is not the HPL region or the engine rotation speed is higher than the predetermined value (NO at step S202), the process proceeds to step S206.

In step S203, the ECU 7 determines that the warm-up condition is satisfied in the internal combustion engine 100. Concretely, the ECU 7 performs the determination on the basis of the water temperature of the cooling water for cooling the engine body 10, or the like. By this determination, the ECU 7 determines whether or not the present water temperature satisfies a water temperature condition such that misfire will not occur even if the recirculation mode is changed from the HPL mode to the LPL mode. That is, in step S203, the ECU 7 determines whether or not there is a possibility of misfire occurring if the recirculation mode is changed from the HPL mode to the LPL mode.

In the case where the warm-up condition is satisfied (YES at step S203), the process proceeds to step S204. In this case, the possibility of occurrence of misfire in the case where the recirculation mode is changed from the HPL mode to the LPL mode can be said to be considerably low. Therefore, the ECU 7 performs the change from the HPL mode to the LPL mode (step S204). Specifically, the ECU 7 performs a control such that EGR gas flows through a path on the low-pressure EGR device side (the low-pressure EGR passage 35). Concretely, the ECU 7 changes the recirculation mode from the HPL mode to the LPL mode by performing the control of closing the high-pressure EGR valve 33 and also opening the low-pressure EGR valve 37. By performing this control, it becomes possible to effectively restrain the occurrence of a change in combustion noise, a change in combustion, etc. when the idling-stop is executed. After the foregoing process ends, the process exits this flow.

On the other hand, in the case where the warm-up condition is not satisfied (NO at step S203), the process proceeds to step S205. In this case, it can be said that there is a possibility of misfire occurring if the recirculation mode is changed from the HPL mode to the LPL mode. Therefore, the ECU 7 performs a control such that exhaust gas is recirculated only by the high-pressure EGR device 50. That is, the change from the HPL mode to the LPL mode is prohibited. For example, the ECU 7 performs a control of maintaining the closed state of the low-pressure EGR valve 37 while maintaining the open state of the high-pressure EGR valve 33. This will restrain the occurrence of misfire resulting from the change to the LPL mode. After the foregoing process ends, the process exits this flow.

In step S206, which follows the negative determination made in step S202, the ECU 7 determines whether or not the low-pressure EGR device 51 is being used and the rotation speed of the internal combustion engine 100 is less than or equal to a predetermined value. In the case where the low-pressure EGR device 51 is being used and the engine rotation speed is less than or equal to the predetermined value (YES at step S206), the process proceeds to step S207. In this case, since exhaust gas is already being recirculated by the low-pressure EGR device 51, the ECU 7 performs a control of increasing the low-pressure EGR proportion (step S207). That is, the ECU 7 performs a control of increasing the dependency on the low-pressure EGR device 51 in order to lessen the dependency on the high-pressure EGR device 50. Therefore, it becomes possible to properly maintain the EGR gas rate and restrain the occurrence of a change in combustion noise, a change in combustion, etc. at the time of execution of the idling-stop. After the foregoing process ends, the process exits the flow.

On the other hand, in the case where low-pressure EGR device 51 is not being used or the engine rotation speed is higher than the predetermined value (NO at step S206), the process proceeds to step S204. In this case, the ECU 7 performs the change from the HPL mode to the LPL mode (step S204). That is, the ECU 7 performs a control such that EGR gas flows through a path (the low-pressure EGR passage 35) provided on the low-pressure EGR device side. After the foregoing process ends, the process exits the flow.

According to the foregoing EGR control process in accordance with the second embodiment, it becomes possible to appropriately restrain the occurrence of misfire of the internal combustion engine 100 and effectively restrain the occurrence of a change in combustion noise, a change in combustion, etc., at the time of execution of the idling-stop.

1. (canceled)

2. The control device according to claim 11, wherein the first EGR device includes a first EGR valve and the second EGR device includes a second EGR valve, that each controls recirculation amount of exhaust gas, and wherein when the idling is to be stopped, the EGR control device performs a control of closing the second EGR valve and opening the first EGR valve.

3. The control device according to claim 2, wherein the EGR control device keeps opening degree of the first EGR valve substantially constant.

4. The control device according to claim 11, wherein if a warm-up condition for the internal combustion engine is not satisfied when the idling is to be stopped, the EGR control device performs a control such that the exhaust gas is recirculated by the second EGR device.

5. The control device according to claim 11, wherein if the exhaust gas is already being recirculated by the first EGR device when the idling is to be stopped, the EGR control device performs such a control as to increase proportion of the exhaust gas recirculated by the first EGR device to a total amount of exhaust gas recirculated by the first EGR device and the second EGR device.

6. A control method for an internal combustion engine, the internal combustion engine including: a first EGR device that recirculates exhaust gas from a location in an exhaust passage at a downstream side of a turbine of a turbocharger to a location in an intake passage at an upstream side of a compressor of the turbocharger; and a second EGR device that recirculates exhaust gas from a location in the exhaust passage at an upstream side of the turbine to a location in the intake passage at a downstream side of the compressor, the control method comprising:
performing a control of changing recirculation of exhaust gas from the recirculation of exhaust gas using the second EGR device to the recirculation of exhaust gas using the first EGR device when idling of the internal combustion engine is to be stopped.

7. The control method wherein according to claim 6, wherein the first EGR device includes a first EGR valve and the second EGR device includes a second EGR valve, that each controls recirculation amount of exhaust gas, and wherein when the idling is to be stopped, a control of closing the second EGR valve and opening the first EGR valve is performed.

8. The control method according to claim 7, wherein opening degree of the first EGR valve is kept substantially constant.

9. The control method according to claim 6, wherein if a warm-up condition for the internal combustion engine is not satisfied when the idling is to be stopped, a control such that the exhaust gas is recirculated by the second EGR device is performed.

10. The control method according to claim 6, wherein if the exhaust gas is already being recirculated by the first EGR device when the idling is to be stopped, such a control as to increase proportion of the exhaust gas recirculated by the first EGR device to a total amount of exhaust gas recirculated by the first EGR device and the second EGR device is performed.

11. A control device for an internal combustion engine, the internal combustion engine including: a first EGR device that recirculates exhaust gas from a location in an exhaust passage at a downstream side of a turbine of a turbocharger to a location in an intake passage at an upstream side of a compressor of the turbocharger; and a second EGR device that recirculates exhaust gas from a location in the exhaust passage at an upstream side of the turbine to a location in the intake passage at a downstream side of the compressor, the control device comprising:
an EGR control device that performs a control of changing recirculation of exhaust gas from the recirculation of exhaust gas using the second EGR device to the recirculation of exhaust gas using the first EGR device when idling of the internal combustion engine is to be stopped.
